(19) United States
(12) Patent Application Publication
(10) Pub. No.: US 2003/0076844 A1
(43) Pub. Date: Apr. 24, 2003

(54) Method and system for filtering a signal and providing echo cancellation using an adaptive length filter

(76) Inventors: Mohammad Usman, Mission Viejo, CA (US); Jon Laurent Pang, Huntington Beach, CA (US); Amjad Luna, Aliso Viejo, CA (US); Imtinan Elahi, Lake Forest, CA (US)

Correspondence Address: O'MELVENY & MYERS LLP, 400 So. Hope Street, Los Angeles, CA, 90071-2899, US

(21) Appl. No.: 10/038,320

(22) Filed: Oct. 19, 2001

(51) Int. Cl. H04L 12/56

(52) U.S. Cl. 370/401

(57) ABSTRACT

The present invention provides for adaptive filters that have improved convergence, computational, and memory bandwidth proprieties. When applied to telecommunication applications, the present invention additionally provides for improved methods and systems of canceling echoes. In one embodiment of the adaptive filter of the present invention, a filter, preferably an adaptive finite impulse response (FIR) filter, of an appropriate length, N, is chosen. Once the filter is chosen, convergence is achieved using a convergence process. With convergence complete, the total energy of the filter coefficients is computed and two energy thresholds, a first energy threshold and a second energy threshold, are set relative to the computed total energy. Using the set energy thresholds, new filter coefficients are determined by relating the starting filter coefficient with the first energy threshold and the end filter coefficient with the second energy threshold. A first filter delay, in accordance with the determined start coefficient, is incorporated into the filter operation.

### FIELD OF THE INVENTION

The present invention relates generally to an adaptive filter with improved operational characteristics, and, more specifically, to methods and systems of achieving echo cancellation employing the improved adaptive filter.

### BACKGROUND OF THE INVENTION

Adaptive filters are used in numerous applications to remove undesired frequencies from a signal. In an exemplary application, adaptive filters are used in telecommunication systems, more specifically in echo cancellation systems, to remove from a signal echoes that may arise as a result of the reflection and/or retransmission of modified input signals back to the originator of the input signals. Commonly, echoes occur when signals that were emitted from a loudspeaker are then received and retransmitted through a microphone (acoustic echo) or when reflections of a far end signal are generated in the course of transmission along hybrids wires (line echo).

Although undesirable, echo is tolerable in a telephone system, provided that the time delay in the echo path is relatively short. But, longer echo delays can be distracting or confusing to a far end speaker. Understandably, the telecommunications industry has devoted substantial resources to developing systems that minimize echo, without adversely affecting the ability of two speakers to communicate with one another.

Acoustic echo often occurs in speakerphones that employ one or more microphones together with one or more speakers to enable “hands-free” telephone communication. Line echo originates because telephone facilities usually comprise two-wire circuits within each area connecting individual subscribers with the switching office and four-wire transmission circuits between switching offices in different local exchange areas. A call between subscribers in different exchange areas is carried over a two-wire circuit in each of the areas and a four-wire circuit between the areas, with conversion of speech energy between the two and four-wire circuits being conducted by hybrid circuits. If the hybrid circuit input ports had perfectly matched impedances of the two and four-wire circuits, the signals transmitted from one exchange area to the other would not be reflected or returned to the first area as echo. Unfortunately, due to impedance differences that inherently exist between different two and four-wire circuits, and because impedances must be matched at each frequency in the voice band, it is difficult for a given hybrid circuit to perfectly match the impedances of any particular two and four-wire transmission circuit.

To substantially remove echoes from a communication system, echo cancellation systems and methods deploy adaptive filters to generate an estimate (echo estimate) of the echo signal that is then removed from the signal being transmitted back to the originator of the echo-generating signal (far-end source). More specifically, a far-end source transmits a signal (far-end signal) that passes through a connection medium and into an input terminal of a communication unit. The far-end signal received at the input terminal is cross-coupled via a cross coupling path (either acoustically or in line) and creates a cross coupling echo component. That echo component combined with a new signal from the near-end (near-end signal) is transmitted back to the far-end source as a composite output signal. In this system, an echo canceller is conventionally deployed to monitor the far-end signal and generate an estimate of the actual echoes expected to return in the form of a composite signal with the near-end signal. The echo estimates are then applied to a subtractor circuit in the transmit channel to remove or at least reduce the actual echo.

To create an accurate estimate of the actual echoes, various types of adaptation methods are known in the prior art and can be deployed in the echo canceller in the form of an adaptive filter. Conventionally, a finite impulse response (FIR) filter is used that carries out the convolution between the far-end signal and the estimated impulse response, N samples in length, of the echo paths. In the most basic model, an adaptive filter (filter vector) operates on a far-end signal vector to produce an estimate of the echo, which is subtracted from the combined near-end and echo signal. The overall output of the adaptive echo canceller is then used to control adjustments made to tap values of the filter vector.

In the aforementioned application, and other applications requiring the use of adaptive filters, a critical design requirement is the ability for the filter system to achieve convergence in a rapid, stable manner and, in the process, use a minimal amount of computational resources. A trade-off traditionally exists between stability, accuracy, and speed of convergence of an adaptive filter. As such, different types of adaptive filter systems have been deployed in echo cancellation systems that attempt to improve the rate of convergence and stability, while still minimizing the computational resources required. U.S. Pat. No. 5,995,620 discloses a method of canceling an echo that, according to the inventors, has an improved convergence time with low complexity. The echo cancellation method includes the step of canceling the echo in a far-end signal with a Kalman filter having a time varying Kalman gain vector K(t) proportional to the vector:

(p₁(t)×(t−1) . . . pₙ(t)×(t−n))^{T}

where pᵢ(t) are the diagonal elements of a diagonal matrix P(t) satisfying a Riccati equation, i denotes the ith diagonal elements of P(t), t denotes discrete time, n denotes the number of filter taps, and T denotes transpose.

Despite the aforementioned prior art, an adaptive filter is still needed that achieves stable convergence using fewer computational resources. Additionally, a method and system of echo cancellation displaying stable convergence, while minimizing the computational resources required, is also needed.

### SUMMARY OF THE INVENTION

The present invention is directed toward a novel adaptive filter and novel methods and systems for conducting echo cancellation in telecommunication systems. In one embodiment of the adaptive filter of the present invention, a filter is chosen, preferably an adaptive finite impulse response (FIR) filter of an appropriate length N. Once the filter is chosen, convergence is achieved using a convergence process. With convergence complete, the total energy of the filter coefficients is computed and two energy thresholds, a first energy threshold and a second energy threshold, are set relative to the computed total energy. Using the set energy thresholds, new filter coefficients are determined by relating the starting filter coefficient with the first energy threshold and the end filter coefficient with the second energy threshold. A first filter delay, in accordance with the determined start coefficient, is incorporated into the filter operation.

In a second embodiment of the present invention, a filter is chosen, preferably an adaptive finite impulse response (FIR) filter of an appropriate length N. Once the filter is chosen, convergence is achieved using a convergence process, preferably a least means square (LMS) approach. With convergence complete, a set of coefficients (Selected Coefficients), which represents a sub-set of the entire set of converged coefficients and is preferably pre-designated but, optionally, may be dynamically chosen, is used to calculate the average energy of the portion of the signal corresponding to the Selected Coefficients. The average energy is then scaled using a scaling factor to produce a threshold value that is used to select the coefficient subset used to filter the signal.

The present invention is also directed toward novel echo cancellation methods and systems that use the novel adaptive filters. Adaptive filters are used to generate an echo signal component used to cancel the echo generated by the engagement of a far-end signal with a cross-coupling path. The novel adaptive filter method and system presented herein can be used to improve the calculation of the echo impulse response by, among other things, reducing the computational complexity and memory requirements of the coefficient calculation conducted within the adaptive filter. In one embodiment, a filter delay is incorporated to insure that only coefficients approximate to or greater than the start coefficient (SC) are employed. In a preferred embodiment, the delay value is a function of the SC minus 1. One of ordinary skill in the art would appreciate that different delay values, as related to SC could be used and depends upon on how much adherence one of ordinary skill in the art would want the designed system to have relative to the calculated SC. The modeled response is produced as a function of the transfer function denoted by z^{-D2}. The values of D₂ extend from the point after the initial delay up to a point proximate to the end coefficient (EC). In a case where the delay is equal to the start coefficient minus 1 and the termination point is chosen to equal the EC, keeping in mind the termination point could be slightly greater than or less than EC, depending upon design considerations, the transfer function z^{-D2} can be modeled as:

z^{-SC} z^{-(SC+1)} z^{-(SC+2)} z^{-(SC+3)} . . . z^{-(EC-3)} z^{-(EC-2)} z^{-(EC-1)} z^{-EC}

Accordingly, the present invention provides for adaptive filters that have improved convergence, computational, and memory bandwidth proprieties. When applied to telecommunication applications, the present invention additionally provides for improved methods and systems of canceling echoes.

### BRIEF DESCRIPTION OF THE DRAWINGS

These and other features and advantages of the present invention will be appreciated as they become better understood by reference to the following Detailed Description when considered in connection with the accompanying drawings, wherein:

FIG. 1 is a flowchart describing the operation of one embodiment of a novel adaptive filter method;

FIG. 2 is a block diagram of one embodiment of the novel adaptive filter system;

FIG. 3 is a flowchart describing the operation of a second embodiment of a novel adaptive filter method;

FIG. 4 is a block diagram of a telecommunication system having a voice over packet gateway;

FIG. 5 is a block diagram of an echo cancellation system; and

FIG. 6 is a block diagram of a novel adaptive filter for use in the echo cancellation system of FIG. 5.

### DETAILED DESCRIPTION OF THE INVENTION

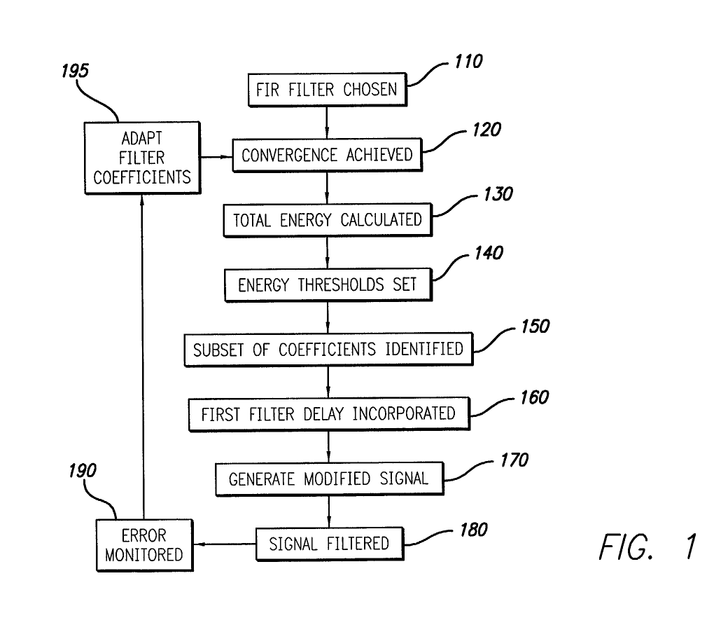

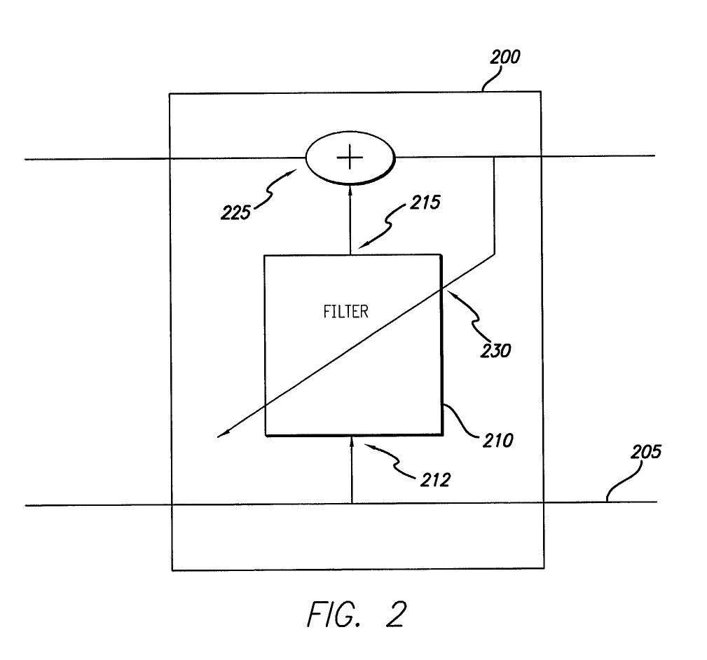

Referring now to FIG. 1, a novel adaptive filter method is shown. A filter is chosen at 110, preferably an adaptive finite impulse response (FIR) filter of an appropriate length N. Once the filter is chosen 110, convergence is achieved 120 using a convergence process, preferably a least means square (LMS) approach. With convergence complete 120, the total energy of the filter coefficients is computed 130 and two energy thresholds, a first energy threshold and a second energy threshold, are set 140 relative to the computed total energy. Using the set energy thresholds, a subset of the converged filter coefficients is identified 150 by relating the starting filter coefficient with the first energy threshold and the end filter coefficient with the second energy threshold. A first filter delay, in accordance with the determined start coefficient, is incorporated 160 into the filter operation. In the filtration process, the converged subset of filter coefficients are then applied 170 to the input signal to create a modified signal used to filter 180 the data through a summation or subtractor circuit in communication with the signal to be filtered. The error between the modified signal and signal to be filtered is monitored 190 and used to adapt 195 the filter coefficients and the process is repeated beginning with step 120. As shown in FIG. 2, the adaptive filter system 200 comprises a filter 210 having a filter input 212 for receiving inputs from a far-end source 205, a filter output 215 for outputting a filtered result to a summation device 225, and an error input 230 for receiving an error signal generated by the comparison of an estimated signal against the actual signal.

The present system will be described in greater detail by specific reference to a finite impulse response (FIR) filter. An FIR system is generally described by the difference equation:

$${y}_{k} = {\sum }_{i = 0}^{N} {h}_{i} {x}_{k - i}$$

where yₖ represents an output signal that is the summation of the convolution of hᵢ with input signal xₖ₋ᵢ. One of ordinary skill in the art would appreciate that there are several methods for implementing an FIR system, including direct form, cascade-form, frequency-sampling, and lattice realizations. While the embodiments of the present invention will be described by reference to a direct form realization, the invention is not limited to direct form realizations and encompass any realization that could be effectively utilized in accordance with the teachings provided herein. Furthermore, while FIR filters are preferred for use in the present invention, a FIR filter form is not necessary and other filter forms, such as infinite impulse response (IIR) filters, could be used.

Designing an FIR filter requires the determination of N coefficients from a specification of the desired frequency response of the FIR filter. One of ordinary skill in the art would appreciate how to design a FIR system for a particular application and, more specifically, to define the appropriate length of the FIR filter. In the case of FIR filters being designed for echo cancellation applications, the desired frequency response of the FIR filter is to mimic the behavior of a cross-coupling transformation of a far-end signal, namely the nature and extent of the impulse response generated by the echo path. As such, the length of the FIR filter, designated by N, is calculated based upon the length of the impulse response that needs to be cancelled. For line echo cancellation, the impulse response is typically specified to be 64 ms in duration. The FIR filter length can therefore be approximated by multiplying the expected duration of the echo response, i.e., 64 ms, by the standard sampling rate in telephony systems, 8 kHz. In this case, the FIR filter would comprise 512 coefficients or 512 taps.

The taps, also referred to as filter coefficients or coefficients, of the FIR filter can be realized by using a convergence process that employs any one of several known approaches. To achieve convergence, the approach would typically have to derive a set of coefficients that, when applied to an input signal, would generate a signal that was sufficiently close to (converged with) the signal that needed to be filtered. In the aforementioned echo cancellation application, the approach would be to update the coefficients once every sample, or every 125 microseconds. The more coefficients that need to be updated, the more computational resources and memory that are needed by the filter system. Reducing the number of coefficients would therefore reduce the computational complexity and memory requirements of the adaptive filter. This reduction becomes even more critical when dealing with applications requiring numerous adaptive filter operations, such as multi-channel echo cancellation devices.

A conventionally used approach to achieve convergence comprises the LMS approach. One of ordinary skill in the art would appreciate the calculation that needs to be conducted in order to conduct a convergence process using the LMS approach. Conceptually, by effectuating convergence, the LMS approach enables the determination of values for a set of coefficients that comprise a transfer function that best approximates the transformation of an input signal to the echo-containing output signal via the cross-coupling pathway. Depending on the length of the FIR filter, the LMS approach can be computationally complex and therefore comprises the most computationally intensive part of any filtration process. Additionally, the LMS approach exhibits slow convergence and requires the trial-and-error determination of an adaptation coefficient, denoted by μ, which controls the speed of convergence and, if improperly selected, effects the stability of the convergence calculation.

Other approaches can be used and may be selected based upon a balance of factors including the rate of convergence, computational requirements, stability, and other properties. The rate of convergence is defined as the number of iterations required for the convergence process, in response to a set of inputs, to converge to the optimum solution. The computational requirements of the convergence process includes: (a) the number of operations (i.e., multiplications, divisions, additions, and subtractions) required to perform one complete iteration of the convergence process; (b) the amount of memory needed to store the convergence process and accompanying data; and (c) the engineering investment required to program the convergence process.

As with other recursive algorithmic approaches, the LMS approach computes the coefficient values from the error signal by starting from some set of initial conditions that preferably approximates an assumed initial state of the system and iteratively configuring the coefficients to minimize the error signal when calculated in some mean-squared sense.

More specifically, given an input vector \overline{u}, and a vector of filter coefficients or weights \overline{w}, then the minimum mean-squared error function can be written as:

J(\overline{w})=σ_{d}²−\overline{w}^{H}\overline{p}−\overline{p}^{H}\overline{w}+R\overline{w},

where σ_{d}² is the variance of the desired signal d(k), R is the auto-correlation matrix of the input signal \overline{u}, and \overline{p} is the cross-correlation between the desired signal d(k) and input U.

The minimum value of J(\overline{w}) is:

$${min }_{\overline{ω}} J ( \overline{w} ) = {σ}_{d}^{2} - {\overline{p}}^{H} R \overline{p}$$

for

\overline{w}ₒₚₜᵢₘₐₗ=R⁻¹\overline{p}.

Here, \overline{w}optimal are the optimal weight of the filter in mean-squared sense. In LMS, the following update is used for the filter weights:

$${\overline{w}}_{n + 1} = {\overline{w}}_{n} + \frac{μ}{2} ∇ J , \qquad ( 1 )$$

where ∇J is the gradient of J:

ΔJ=2E[\overline{u}ₖ^{H}{d(k)−\overline{w}ₖ^{T}\overline{u}ₖ}]

where E denotes a statistical expectation. The term in braces in the above equation is the error between the desired and estimated signal, which can be defined as:

e(k)=(d(k)−\overline{w}ₖ^{T}\overline{u}ₖ)

In LMS, the statistical expectation is estimated by the instantaneous value of the gradient. Therefore:

\overline{w}ₖ₊₁=\overline{w}ₖ+μe(n)\overline{u}ₖ, (2)

It has been shown that the proper choice of μ should be:

$$0 < μ < \frac{2}{{λ}_{max}} ,$$

where λₘₐₓ is the maximum eigenvalue of the auto-correlation matrix R. Since R is not known and, therefore, λₘₐₓ is not known, one cannot necessarily choose a good value of μ. In practice, a value for μ is usually chosen by trial-and-error. The value of μ affects the filter performance. Smaller values of μ give higher signal-to-noise ratio but take more time to converge. Usually, a designer starts with a relatively large value of μ for fast initial convergence, and then chooses a smaller value for high SNR.

In a preferred embodiment, after convergence is achieved on the FIR filter using the above-described LMS method, the total coefficient energy is then computed. Total energy can be calculated based upon the coefficients, represented by w as calculated above, in accordance with the following equation:

$$E = {\sum }_{i = 0}^{N - 1} {\overline{w}}_{i}^{2}$$

where the energy calculation is performed over a set of i samples. As is known by those skilled in the art, the total energy of a signal can be computed through other equations, such as:

$$E = {\sum }_{i = 0}^{N - 1} \vert {\overline{w}}_{i} \vert$$

The present invention is not limited to a single method for calculating energy and can be effectuated through any total energy calculation approach.

In certain applications, such as echo cancellation, it is observed that energy levels vary over the course of a signal to be filtered and, as between signals, vary in profile and distribution. Because filter systems need to be designed to be long enough to filter the most substantial undesired frequencies likely to be received, they are often longer than necessary to account for many of the actual undesired signals encountered. More specifically, when dealing with line echo cancellation, it is known that an effective echo cancellation system should account for, at minimum, 32 milliseconds (ms) of delay. It is observed, however, that a substantial number of hybrid impulse responses do not have significant energy levels extending throughout the typical 5-15 ms duration and, therefore, where sampling and coefficient calculation has occurred to obtain coverage of a 5-15 ms duration echo, a majority of energy resides in only a subset of the total impulse response samples taken.

As an example, a typical hybrid impulse response, caused by a specific far-end signal and sampled at 8000 Hz, may have a majority of the signal energy concentrated in the first few or the last few samples. A conventional filter having a length equal to 512 coefficients would therefore have a majority of its coefficients corresponding to energy levels at or near zero. Consequently, the filter process would use memory and computational resources for calculating and storing values that does not significantly improve system performance, reduce the signal to noise ratio, or improve filter quality. While possible to simply fix the filter at a smaller length, a smaller fixed filter length would prevent the system from being able to effectively respond to changes in the impulse response.

Referring back to FIG. 1, once convergence is achieved 120 and the total energy is calculated, two energy thresholds, a first energy threshold and a second energy threshold, t₁ and tₕ respectively, are set 140 relative to the computed total energy. The values for t₁ and tₕ denote the boundary that defines the selected portion of total energy to be filtered. The thresholds are calculated by applying a lower-end, p₁, and higher-end, Pₕ, cutoff, in the form of percentages, to the total energy E. In echo cancellation applications, it is preferred that substantially all of the impulse response energy be filtered (approximately 99.99% of E) and, as such, the values for p₁ and Pₕ are 0.001% and 99.991%. One of ordinary skill in the art would appreciate, however, that the present invention is not limited to specific values for p₁ or Pₕ. Those values can be selected by balancing quality considerations (requiring a larger portion of E to be filtered and therefore for p₁<<<pₕ) with the computational resources available (requiring fewer coefficients to be considered and therefore the difference between pi and Ph need not be as great). The values for t₁ and tₕ are then calculated in accordance with the following equations:

t₁=p₁*E

tₕ=pₕ*E

Therefore, the two energy thresholds are approximately 0.001% of total energy E and approximately 99.99% of total energy E. The two thresholds bound 99.99% of the total energy to be filtered.

With the two energy thresholds calculated, the filter of length N can be truncated in operation to only address a subset of all N coefficients corresponding to the energy bounded by t₁ and tₕ. Using t₁ and tₕ, corresponding start and an end coefficients are calculated by the following algorithm:

Initial conditions:

Eₜ=0 and k=1

Calculation:

While Eₜ<t₁

$${E}_{t} = {E}_{t} + {\sum }_{i = 0}^{k - 1} {\overline{w}}_{i}^{2}$$

k=k+1

endwhile

Start_Coefficient=k

While Eₜ+t₁<tₕ

$${E}_{t} = {E}_{t} + {\sum }_{i = 0}^{k - 1} {\overline{w}}_{i}^{2}$$

k=k+1

endwhile

End_Coefficient=k

Start_Coefficient and End_Coefficient denote the coefficient boundaries associated with the calculated energy boundaries.

A filter delay, in accordance with the determined start filter coefficient, is incorporated into the filter operation. The delay can be incorporated through any method or system capable of accurately bypassing coefficients approximately less than the Start_Coefficent and initiating coefficient usage around or at Start_Coefficient. An exemplary method would comprise adjusting a filter data pointer to a position associated with Start_Coefficient or slightly less than Start_Coefficient. In the course of operation, after bypassing initial coefficients to reach at or about Start_Coefficient, the filter applies the coefficients approximate to or greater than Start_Coefficient and less than or approximate to End_Coefficient to model the signal to be filtered, terminating at or around End_Coefficient. Where p₁<<<Pₕ, the application of a subset of total coefficients delivers substantially similar filtration quality to the application of all coefficients, but with fewer computational and memory resources required.

In operation, the coefficients are converged, total energy is calculated, the lower and upper energy thresholds are calculated, the corresponding start and end coefficients are determined, and, with those start and end coefficients, a subset of all coefficients is identified. As shown in FIG. 1, the identified subset is then used to filter a signal by applying the identified subset of coefficients to an input signal, generating a modified input signal, and applying that input signal to the signal to be filtered in order to remove the undesired frequencies modeled by the application of the coefficient subset to the input signal. One of ordinary skill in the art would appreciate that the filter process can be conducted in numerous ways and that the present invention is not limited to a specific method for using the identified coefficient subset for filtration.

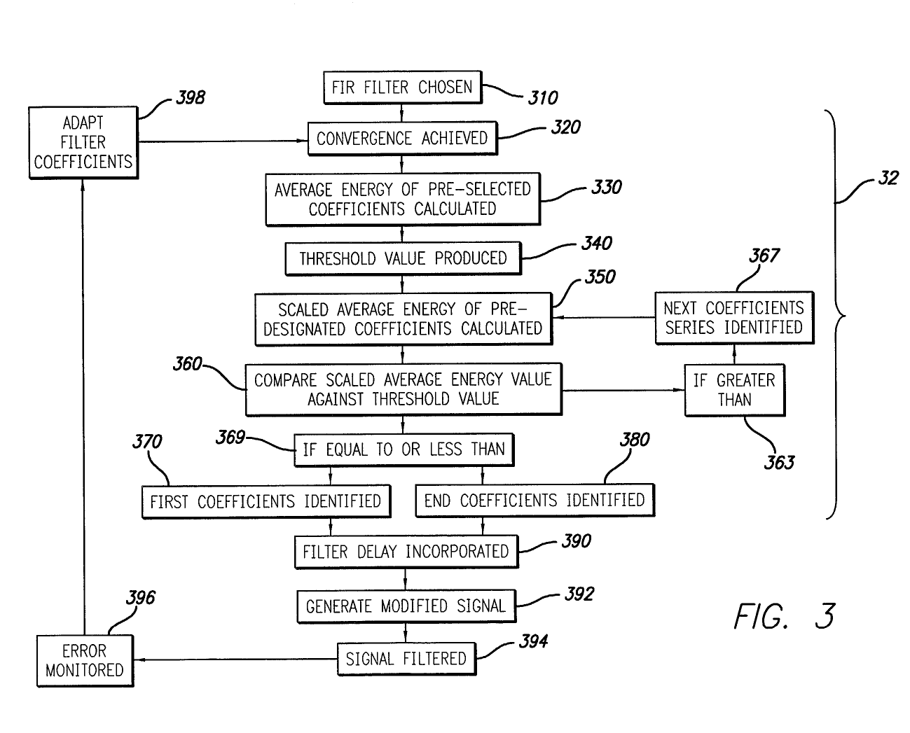

Referring now to FIG. 3, a second embodiment of the present invention provides for selection 310 of a filter, preferably an adaptive finite impulse response (FIR) filter of an appropriate length N. Once the filter is chosen 310, convergence is achieved 320 using a convergence process, preferably a least means square (LMS) approach. With convergence complete 320, the process to identify a subset of converged coefficients is initiated 325. A set of coefficients (Selected Coefficients), which represents a sub-set of the entire set of converged coefficients and is preferably pre-designated but, optionally, may be dynamically chosen, is used to calculate 330 the average energy of the portion of the signal corresponding to the Selected Coefficients. The average energy is then scaled using a scaling factor to produce 340 a threshold (herein referred to as a threshold value) against which the rest of the coefficient are to be evaluated.

Starting from a specific coefficient, preferably the first coefficient, the average energy value of a series of coefficients, where the series number is equal to the number of Selected Coefficients, is calculated 350. This value is then compared 360 against the previously calculated threshold value. If the previously calculated threshold value is greater than 363 the value calculated by step 350, the next coefficient series, once again where the series number is equal to the number of Selected Coefficients, is selected 367 and evaluated in the same manner as steps 350 and 360. If the previously calculated threshold value is equal to or less than 369 the value calculated by step 350, the first coefficients of the subset of converged coefficients have been identified 370. In parallel or in series, the last coefficients of the subset of converged coefficients can be identified 380 in a similar manner by performing the same calculation, except beginning with the end coefficient and having the series move toward the first coefficient. Alternatively, the end coefficient can be identified by adding a fixed number of coefficients to the start coefficient to yield an end coefficient.

The selection of the Selected Coefficients can be performed by any method, most preferably using those methods that are appropriate to the application to which the adaptive filter is being applied. For example, the Selected Coefficients can be a pre-designated set of coefficients with fixed start and end coefficients that may correspond to a reliably present energy presence in the signal to be filtered. Alternatively, the Selected Coefficients can comprise a fixed start coefficient with variable end coefficients depending on the signal strength of the fixed start coefficient. Where computational resources and time permit, the Selected Coefficients can also be dynamically chosen by selecting the set of coefficients having the highest signal strength. One of ordinary skill in the art would appreciate that nearly any method can be used to identify the Select Coefficients and such methods are preferably unique to the adaptive filter application. More specifically, the Selected Coefficients are preferably selected based upon a best estimate as to what area, in the signals to be filtered, would typically comprise noise. While signals can vary greatly, within a particular application area, signals often have at least one area that could be predictably assumed to predominantly comprise noise. For example, within echo cancellation applications, the end coefficients of a typical line echo tend to predominantly comprise noise due to propagation delay. Therefore, it is preferred to select a portion of such end coefficients as the Selected Coefficients. It is further preferred to use between 10 and 20 (more preferably 16) of the last end coefficients. One of ordinary skill in the art would appreciate that which coefficients are selected, and the number of coefficients selected, depends upon the nature of the application and the type of signals expected.

With both the start and end coefficients identified 370, 380, a first filter delay, in accordance with the determined start coefficient, is incorporated 390 into the filter operation. In the filtration process, the converged subset of filter coefficients are then applied 392 to the input signal to create a modified signal used to filter 394 the data through a summation or subtractor circuit in communication with the signal to be filtered. The error between the modified signal and signal to be filtered is monitored 396 and used to adapt 398 the filter coefficients and the process, beginning with step 320, is repeated.

In a preferred embodiment, after a filter is chosen, preferably a FIR filter, and convergence is achieved, preferably using the LMS method, the average energy of the Selected Coefficients is calculated. The average coefficient energy for the Selected Coefficients series is computed. Average energy can be calculated based upon the Selected Coefficients, represented by \overline{w} as calculated above, in accordance with the following equation:

$$A v e r a g e E = {\sum }_{{ i = X}_{M - x }}^{M} {\overline{w}}_{i}^{2}$$

where the energy calculation is performed over a set of i samples. As previously stated, the average energy of a signal can be computed through other equations and the present invention is not limited to a single method for calculating average energy. Where the last 16 taps of a filter of length N=512 are selected, as is preferred for echo cancellation applications, the values for x and M are 496 and 512 respectively.

With the average energy calculated for the Selected Coefficients, the average energy is then scaled using a scaling factor. The scaling factor is experimentally determined in accordance with the nature of the application for which the adaptive filter is being used. Higher scaling factors generate higher threshold values, thereby providing for less echo cancellation, lower filter quality, and higher computational and memory resource savings. Lower scaling factors generate lower threshold values, thereby providing for higher echo cancellation, greater filter quality, and lower computational and memory resource savings. One of ordinary skill would appreciate the scaling factor is dependent upon the type of application to be filtered. In echo cancellation applications, it is preferred to use a scaling factor of 4. The threshold value (TV) is therefore average energy (AvgE), as calculated above, times the scaling factor (SF):

TV=AvgE*SF

With TV calculated, each series of coefficients, where a series is equal to M-x (the number of Selected Coefficients), is evaluated by calculating the series' average energy times the scaling factor. While one can begin the series at any place, particularly if it is known that a signal tends to appear at or around specific coefficients, for echo cancellation applications, it is preferred to begin with the first coefficient and move up an incremental M-x number of coefficients in each series. By selecting windows of coefficients, one can incrementally compare each series against the threshold value to determine whether a portion of the converged coefficient set exceeds a base noise energy level and, therefore, represents a signal to be filtered. If so, the coefficients corresponding to that set are relevant to an on-going filtration process. If not, the coefficients are not relevant and are using computational and memory resources unnecessarily. By basing the comparison process against a known signal area to contain noise, one can have a signal to noise ratio based method of truncating a filter to efficiently filter an incoming signal.

Assuming that the beginning point is the first coefficient, k is equal to the number of Selected Coefficients, SC is equal to a start coefficient, and TV is equal to a previously calculated threshold value:

Initialization

SAvgE=0; SC=0

Calculation:

While TV>SAvgE

SAvgE=0; SC=SC+k

$$S A v g E = {\sum }_{{i = S C}_{k}}^{S C + k} {\overline{w}}_{i}^{2}$$

endwhile

Start_Coefficient=SC

Start_Coefficient is the first coefficient in the tested series. As an example, assuming the scaled average energy of coefficient series 18 to 34 exceeded the threshold value, the start coefficient (SC or Start_Coefficient) would be 18. One of ordinary skill in the art would appreciate that protection mechanisms could be incorporated into the above calculation to protect against situations where, for example, the requirement TV<SAvgE is not met and SC begins to exceed the total length of the filter.

The end coefficient can be identified in the same manner, except beginning with the last coefficient and moving the series backward by a number of coefficients equal to the pre-selected number of coefficients. For example, the above calculation would begin with SC=512 (assuming a filter of length N=512) and then incrementally moving downward by 16 (assuming k=16) through a modification of SC=SC+k to SC=SC−k. Alternatively, the end coefficient could be a fixed number of coefficients after the start coefficients, assuming the fixed number yields an end coefficient less than or equal to the total filter length.

With the start coefficient and end coefficients identified, the coefficient boundaries are established and the subset of coefficients for use in the filtration process have been determined. A filter delay, in accordance with the determined start coefficient, is incorporated into the filter operation. The delay can be incorporated through any method or system capable of accurately bypassing coefficients approximately less than the start coefficient and initiating coefficient usage around or at the start coefficient. An exemplary method would comprise adjusting a filter data pointer to a position associated with the start coefficient or slightly less than the start coefficient. In the course of operation, after bypassing initial coefficients to reach at or about the start coefficient, the filter applies the coefficients approximate to or greater than the start coefficient and less than or approximate to the end coefficient to model the signal to be filtered, terminating at or around the end coefficient.

In operation, the coefficients are converged, energy is calculated for the Selected Coefficients, the energy threshold is calculated, the corresponding start and end coefficients are determined, and, with those start and end coefficients, a subset of all coefficients is identified. The identified subset is then used to filter a signal by applying the identified subset of coefficients to an input signal, generating a modified input signal, and applying that input signal to the signal to be filtered in order to remove the undesired frequencies modeled by the application of the coefficient subset to the input signal. One of ordinary skill in the art would appreciate that the filter process can be conducted in numerous ways and that the present invention is not limited to a specific method for using the identified coefficient subset for filtration.

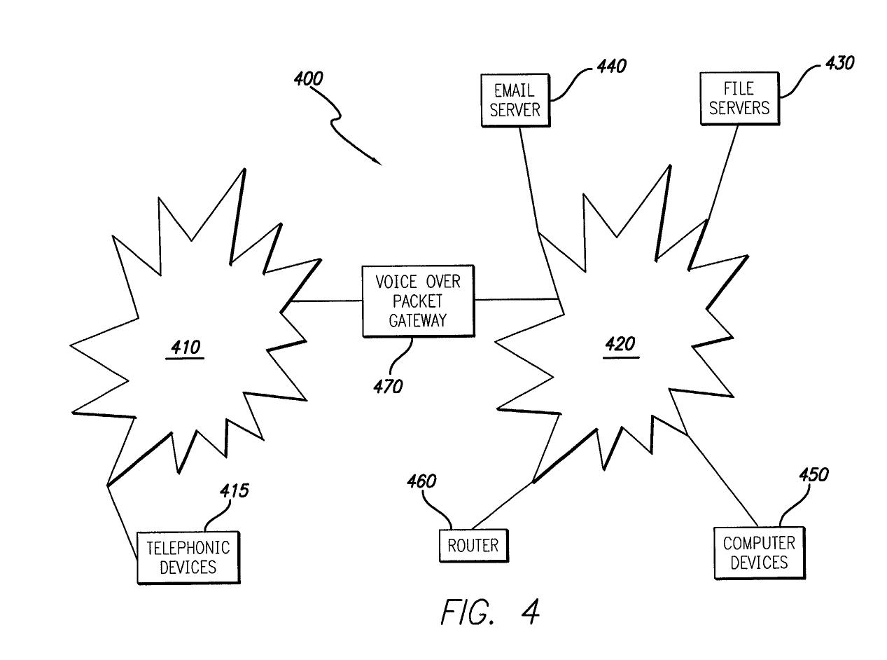

The above-described novel adaptive filter methods and systems can be effectively deployed in a telecommunications system in the form of novel echo cancellation methods and systems to effectuate high quality communications, particularly as between users of a public switched telephone network (PSTN) and users of a packet based network (e.g., the Internet). Referring to FIG. 4, a telecommunication system 400 is shown comprising a PSTN 410 having a plurality of telephonic systems 415 (e.g., telephones and fax machines) and a packet based network 420 having a plurality of networked systems (e.g., file servers 430, email servers 440, computers 450) linked via routers 460. Mediating between the two networks is a gateway 470 comprising a plurality of echo cancellation devices capable of substantially reducing echo generated by the movement of received inputs through various cross-coupling pathways, and a plurality of digital to analog and analog to digital encoders and decoders. Because of the potential volume of signals traveling through such a system 400, echo cancellation can be occurring on numerous channels, carrying different signals, concurrently. It is therefore important to optimize echo cancellation in a manner that reduces the computational complexity and memory requirements associated with the echo cancellation process. The novel adaptive filter method and system provided herein can be used to achieve such a result.

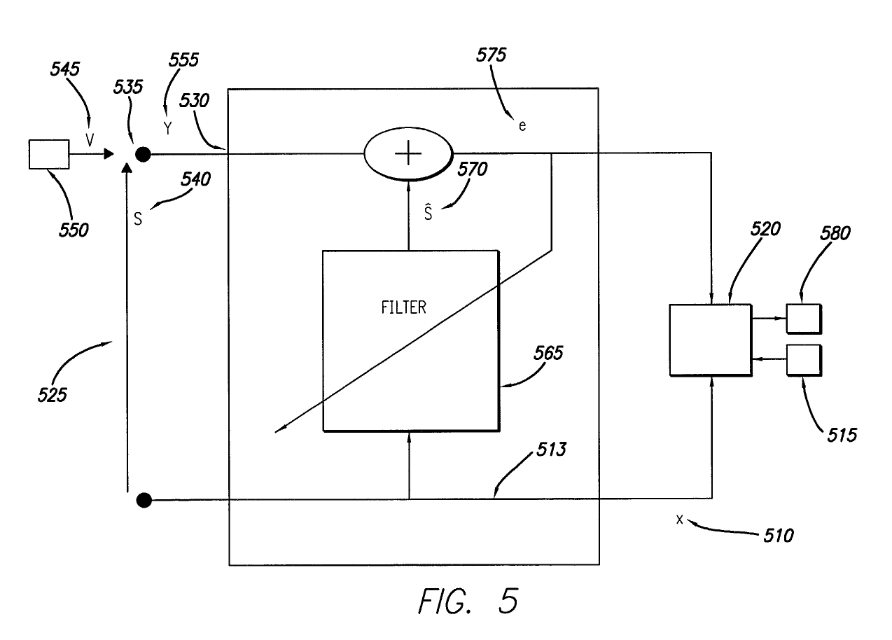

Referring to FIG. 5, a far-end signal x 510 from a far-end source 515 is received locally at a communication input 520. As a result of the previously noted imperfections in the local system, a portion of the signal x 510 is echoed back to a transmit line 530 via a cross-coupling path 525 that intersects with the transmit line 530 at an input 535. In the course of engaging the cross-coupling path 525, whether an acoustic or line echo pathway, the signal x 510 undergoes a transformation, as a function of an impulse response, that modifies the original signal x 510 into a new signal s 540, referred to herein as the echo response 540. The echo response 540 is illustrated here as a signal s 540 corresponding to the following equation:

s=h*x

where h is the impulse response of the echo characteristics.

Also being communicated through the transmit line 530 is a near-end signal v 545, communicated from a near-end source 550. The input signal v 545 combines with the echo response s 540 to generate a combined signal y 555. Therefore, the signal sent from the near-end source 550 to the far-end receiver 580, absent echo cancellation, is the signal y 555, which is the sum of the near-end signal v 545 and the echo response s 540.

To reduce and/or eliminate the echo response component s 540 from the signal y 555, a typical system uses an echo canceller 560 having a filter 565 that is capable of applying an impulse response ĥ, which is an estimate of the actual impulse echo response h experienced by the far-end signal x 510 as it engages the cross-coupling path 525. As such, a further signal §570 representing an estimate of echo response s 540 is generated by the echo canceller 560 in accordance with the following equation:

ŝ=ĥ*x

The echo canceller 560 subtracts the echo estimate signal ŝ 570 from the signal y 555 to generate a signal e 575 that is returned to the far-end receiver 580. The signal e 575 thus corresponds to the following equation:

e=s+v−ŝ≈v

The signal returned to the far end receiver 580 is therefore dominated by the signal v of the near-end source 550. To the extent the impulse response ĥ more closely correlates to the actual echo impulse response h, then ŝ 570 more closely approximates s 540, resulting in the minimization of the magnitude of the echo signal component s 540 on the signal e.

An adaptive filter 565 is used to generate the echo signal component ŝ 570. In its simplest form, the adaptive filter 565 generates an echo estimate, i.e., ŝ 570, by obtaining individual samples of the far-end signal x 510 on a receive path 513, convolving the samples with an impulse response model of the system, i.e., ĥ, and then subtracting, at the appropriate time, the resulting echo estimate, ŝ 570, from the received signal y 555 on the transmit channel 530. The conventional adaptive filter is a FIR filter using a LMS method for achieving tap convergence.

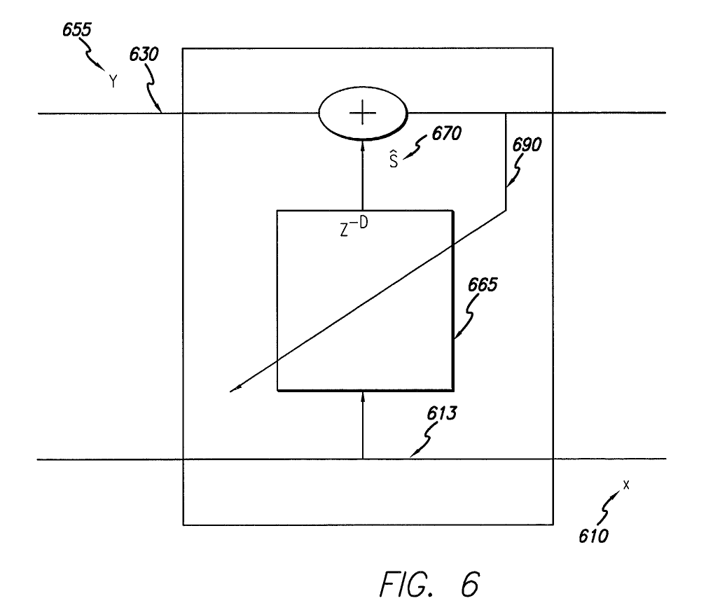

The novel adaptive filter methods and systems presented herein can be used to improve the calculation of the echo impulse response ĥ by, among other things, reducing the computational complexity and memory requirements of the coefficient calculation conducted within the adaptive filter. Shown in FIG. 6, an embodiment of the novel filter 665 of the present invention is used to generate the echo signal component ŝ 670. After having achieved convergence on a FIR filter and truncated the filter, in accordance with either one of the previously described methodologies, the adaptive filter 665 generates an echo estimate, i.e., ŝ 670, by obtaining individual samples of the far-end signal x 610 on a receive path 613, convolving the samples with the calculated coefficients, and then subtracting, at the appropriate time, the resulting echo estimate, ŝ 670, from the received signal y 655 on the transmit channel 630. Ongoing adaptation of the filter occurs by the adjustment of the filter coefficients, represented by the arrow 690 extending through element 665.

To provide a delay to insure that only coefficients approximate to or greater than the SC are employed, a delay is applied where D−1 is a specific value of delay related to the value of SC. The start and end coefficients may have been calculated using either of the first or the second novel adaptive filter methods and systems described above. In a preferred embodiment, D is equal to SC so the delay is equal to SC−1. One of ordinary skill in the art would appreciate that different values of a delay, as related to SC could be used and depends upon how much adherence one of ordinary skill in the art would want the designed system to have relative to the calculated SC. Some may prefer to strictly adhere to the calculated threshold (delay=SC−1). Others may prefer to incorporate a greater buffer (delay <<SC) in order to insure greater quality while sacrificing some of the potential computational and memory resource savings.

The signal ŝ 670 is produced as a function of the transfer function denoted by z^{-D} 685. The values of D extend from the point after the initial delay up to a point proximate to the EC. In a case where the delay is equal to SC−1 and the termination point is chosen to equal EC, keeping in mind the termination point could be slightly greater than or less than EC, depending upon design considerations, the transfer function z^{-D} 685 can be modeled as:

z^{-SC} z^{-(SC+1)} z^{-(SC+2)} z^{-(SC+3)} . . . z^{-(EC-3)} z^{-(EC-2)} z^{-(EC-1)} z^{-EC}

Operationally, the novel echo cancellation application has achieved superior performance results. Applying an echo cancellation system using the first novel adaptive filter to a conventional hybrid response, a FIR filter of length N=512 was chosen and converged according to the standard LMS approach. Using this conventional approach, the signal to noise ratio was 48 dBs. Using the approach of the present invention, a FIR filter of length n=512 was chosen, converged using a LMS approach, and subjected to a low and high threshold, set at 0.001% and 99.99% of the total energy. The resulting threshold application bounded the start and end coefficients at 51 and 127 respectively, reducing the filter length to 77. The filter result was acceptable, producing a signal to noise ratio of 42 dBs. Without an unacceptable decrease in performance, the present invention provided for a substantially reduced filter length and therefore a reduced computational and memory resource burden.

The present adaptive filter method and system can be employed in numerous applications employing adaptive processes in conjunction with convolutional coding. Accordingly, another embodiment of the present invention includes a novel method and system for channel equalization. Equalizers are a class of communication system devices used to compensate for distortion experienced in communication channels. Fixed equalizers have the average electrical characteristics of the channel pre-determined and a fixed amount of equalization is therefore designed into the equalizer to compensate for the distortion. Adjustable equalizers monitor the channel and provide for equalization that varies, as necessary, to match the distortion determined at the time of monitoring. Adjustable equalizers, also known as adaptive equalizers, can provide for the adaptation using an adaptive process to generate a modified signal, capable of canceling out distortions in the signal, or an equalizing signal.

Applied to a channel equalization application, the present invention is used to generate the equalizing signal by achieving convergence on a FIR filter, truncating the filter in accordance with either the first or second novel adaptive process disclosed herein, and generating a equalizing signal by obtaining samples of a received signal and convolving the samples with the calculated coefficients. The channel equalizer then applies, at the appropriate time, the resulting equalizing signal to the received signal. Ongoing adaptation of the filter occurs by utilizing an error signal, generated from a comparison of the equalizing signal to the received signal, and adjusting the coefficients based upon the error signal to obtain convergence.

To provide a delay to insure that only coefficients approximate to or greater than the start coefficient (hereafter abbreviated as SC) are employed, a delay is applied where D−1 is a specific value of delay related to the value of SC. The start and end coefficients may have been calculated using either of the first or the second novel adaptive filter methods and systems described above. In a preferred embodiment, D is equal to SC so the delay is equal to SC−1. One of ordinary skill in the art would appreciate that different values of a delay, as related to SC could be used and depends upon on how much adherence one of ordinary skill in the art would want the designed system to have relative to the calculated SC. Some may prefer to strictly adhere to the calculated threshold (delay=SC−1). Others may prefer to incorporate a greater buffer (delay<<SC) in order to insure greater quality while sacrificing some of the potential computational and memory resource savings.

The equalizing signal is produced as a function of the transfer function denoted by z^{-D}. The values of D extend from the point after the initial delay up to a point proximate to the end coefficient (hereafter abbreviated as EC). In a case where the delay is equal to SC−1 and the termination point is chosen to equal EC, keeping in mind the termination point could be slightly greater than or less than EC, depending upon design considerations, the transfer function Z^{-D} 785 can be modeled as:

z^{-SC} z^{-(SC+1)} z^{-(SC+2)} z^{-(SC+3)} . . . z^{-(EC-3)} z^{-(EC-2)} z^{-(EC-i)} z^{-EC}

The present methods and systems provide for an adaptive filter that significantly reduces the memory requirement, memory bandwidth, and computational resources necessary to operate the filter. Applied to the problem of echo cancellation, embodiments of the present invention obtained a reduction of computational resource usage while maintaining an acceptable performance level. While various embodiments of the present invention have been shown and described, it would be apparent to those skilled in the art that many modifications are possible without departing from the inventive concept disclosed herein. For example, the adaptive filter has been applied in an echo cancellation application. It would be appreciated by one of ordinary skill in the art that the filter can be used in any application where the convergence, stability, computational requirements, and memory bandwidth characteristics of the novel filtration method and system could be effectively applied.

What is claimed is:

1. An adaptive filter, comprising:
a filter input for receiving a first signal;
a filter output for outputting a second signal based upon said first signal;
an error input for receiving an error signal;
a plurality of first coefficients, each having an associated energy, wherein said first coefficients are modified based upon the error signal; and
a plurality of second coefficients having a start coefficient and an end coefficient, the second coefficients being a subset of the first coefficients, wherein the start coefficient and end coefficient are determined by applying at least one threshold value to an energy value, said energy value being a function of the energy of a plurality of first coefficients.

2. The adaptive filter of claim 1 wherein the at least one threshold value comprises a low-end threshold value and a high-end threshold value.

3. The adaptive filter of claim 2 wherein the low-end threshold value is a predetermined percentage of a sum of the energy of the plurality of first coefficients.

4. The adaptive filter of claim 3 wherein the predetermined percentage is less than one percent.

5. The adaptive filter of claim 3 wherein the start coefficient is determined by identifying a first coefficient having an associated energy substantially equal to the low-end threshold value multiplied by the predetermined percentage of a sum of the energy of the plurality of first coefficients.

6. The adaptive filter of claim 2 wherein the high-end threshold value is a predetermined percentage of a sum of the energy of the plurality of first coefficients.

7. The adaptive filter of claim 6 wherein the predetermined percentage is greater than ninety-nine percent.

8. The adaptive filter of claim 6 wherein the end coefficient is determined by identifying a last coefficient having an associated energy substantially equal to the high-end threshold value multiplied by the predetermined percentage of a sum of the energy of the plurality of first coefficients.

9. The adaptive filter of claim 5 wherein said second set of coefficients comprises the start coefficient, the end coefficient, and substantially all first coefficients bounded by said start coefficient and said end coefficient.

10. The adaptive filter of claim 9 wherein the second signal is derived as a function of the second set of coefficients.

11. The adaptive filter of claim 1 wherein the at least one threshold value is determined by selecting a first subset of first coefficients having an average energy and a number of coefficients, selecting a scaling factor, and multiplying the average energy of said subset of first coefficients times the scaling factor.

12. The adaptive filter of claim 11 wherein the scaling factor is between 0 and 10

13. The adaptive filter of claim 12 wherein the scaling factor is 4.

14. The adaptive filter of claim 11 wherein the subset of first coefficients is selected by selecting a final portion of the first coefficients, the final portion comprising at least 5 coefficients.

15. The adaptive filter of claim 14 wherein the final portion comprises 16 coefficients.

16. The adaptive filter of claim 11 wherein the start coefficient is determined by selecting a second subset of first coefficients having an average energy, a first coefficient, and a number of coefficients substantially equal to the number of coefficients in the first subset of first coefficients, obtaining a scaled average energy by multiplying the average energy of said second subset times the scaling factor, comparing the threshold value to the scaled average energy, and, if the threshold value is less than or substantially equal to the scaled average energy, equating the start coefficient to the first coefficient of the second subset of first coefficients.

17. The adaptive filter of claim 11 wherein the end coefficient is determined by selecting a final subset of first coefficients having an average energy, a final coefficient, and a number of coefficients substantially equal to the number of coefficients in the first subset of first coefficients, obtaining a scaled average energy by multiplying the average energy of said second subset times the scaling factor, comparing the threshold value to the scaled average energy, and, if the threshold value is less than or substantially equal to the scaled average energy, equating the end coefficient to the final coefficient of the final subset of first coefficients.

18. The adaptive filter of claim 16 wherein said second set of coefficients comprises the start coefficient, the end coefficient, and substantially all first coefficients bounded by said start coefficient and said end coefficient.

19. The adaptive filter of claim 9 wherein the second signal is derived as a function of the second set of coefficients.

20. A process for filtering a signal, comprising the steps of:
deriving a plurality of second coefficients having a start coefficient and an end coefficient, the second coefficients being a subset of a plurality of first coefficients, wherein the start coefficient and end coefficient are determined by applying at least one threshold value to an energy value, said energy value being a function of the energy of a plurality of first coefficients;
receiving a first signal;
outputting a second signal wherein the second signal is a function of the second coefficients and the first signal;
receiving an error signal; and
updating the first coefficients based upon said error signal.

21. The process of claim 20 wherein the at least one threshold value comprises a low-end threshold value and a high-end threshold value.

22. The process of claim 21 wherein the low-end threshold value is a predetermined percentage of a sum of the energy of the plurality of first coefficients.

23. The process of claim 22 wherein the predetermined percentage is less than one percent.

24. The process of claim 22 wherein the start coefficient is determined by identifying a first coefficient having an associated energy substantially equal to the low-end threshold value multiplied by the predetermined percentage of a sum of the energy of the plurality of first coefficients.

25. The process of claim 21 wherein the high-end threshold value is a predetermined percentage of a sum of the energy of the plurality of first coefficients.

26. The process of claim 25 wherein the predetermined percentage is greater than ninety-nine percent.

27. The process of claim 25 wherein the end coefficient is determined by identifying a last coefficient having an associated energy substantially equal to the high-end threshold value multiplied by the predetermined percentage of a sum of the energy of the plurality of first coefficients.

28. The process of claim 24 wherein said second set of coefficients comprises the start coefficient, the end coefficient, and substantially all first coefficients bounded by said start coefficient and said end coefficient.

29. The process of claim 28 wherein the second signal is derived as a function of the second set of coefficients.

30. The process of claim 20 wherein the at least one threshold value is determined by selecting a first subset of first coefficients having an average energy and a number of coefficients, selecting a scaling factor, and multiplying the average energy of said subset of first coefficients times the scaling factor.

31. The process of claim 30 wherein the scaling factor is between 0 and 10

32. The process of claim 31 wherein the scaling factor is 4.

33. The process of claim 20 wherein the subset of first coefficients is selected by selecting a final portion of the first coefficients, the final portion comprising at least 1 coefficient.

34. The process of claim 33 wherein the final portion comprises 16 coefficients.

35. The process of claim 20 wherein the start coefficient is determined by selecting a second subset of first coefficients having an average energy, a first coefficient, and a number of coefficients substantially equal to the number of coefficients in the first subset of first coefficients, obtaining a scaled average energy by multiplying the average energy of said second subset times the scaling factor, comparing the threshold value to the scaled average energy, and, if the threshold value is less than or substantially equal to the scaled average energy, equating the start coefficient to the first coefficient of the second subset of first coefficients.

36. The process of claim 20 wherein the end coefficient is determined by selecting a final subset of first coefficients having an average energy, a final coefficient, and a number of coefficients substantially equal to the number of coefficients in the first subset of first coefficients, obtaining a scaled average energy by multiplying the average energy of said second subset times the scaling factor, comparing the threshold value to the scaled average energy, and, if the threshold value is less than or substantially equal to the scaled average energy, equating the end coefficient to the final coefficient of the final subset of first coefficients.

37. The process of claim 35 wherein said second set of coefficients comprises the start coefficient, the end coefficient, and substantially all first coefficients bounded by said start coefficient and said end coefficient.

38. The process of claim 37 wherein the second signal is derived as a function of the second set of coefficients.

39. An echo cancellation system for canceling echo within a second signal generated by the transmittal of a first signal through a cross-coupling pathway, comprising:
a device for summing a third signal and the second signal to produce an error signal; and
an adaptive filter comprising a filter input for receiving the first signal, a filter output for outputting the second signal based upon said first signal, an error input for receiving the error signal, a plurality of first coefficients, each having an associated energy, wherein said first coefficients are updated based upon the error signal, and a plurality of second coefficients having a start coefficient and an end coefficient, the second coefficients being a subset of the first coefficients, wherein the start coefficient and end coefficient are determined by applying at least one threshold value to an energy value, said energy value being a function of the energy of a plurality of first coefficients.

40. The echo cancellation system of claim 39 wherein the start coefficient is determined by identifying a first coefficient having an associated energy substantially equal to a first pre-determined percentage of a sum of the energy of the plurality of first coefficients, and the end coefficient is determined by identifying a last coefficient having an associated energy substantially equal to a second pre-determined percentage of a sum of the energy of the plurality of first coefficients.

41. The echo cancellation system of claim 39 wherein the at least one threshold value is determined by selecting a first subset of first coefficients having an average energy and a number of coefficients, selecting a scaling factor, and multiplying the average energy of said subset of first coefficients times the scaling factor.

42. The echo cancellation system of claim 41 wherein the start coefficient is determined by selecting a second subset of first coefficients having an average energy, a first coefficient, and a number of coefficients substantially equal to the number of coefficients in the first subset of first coefficients, obtaining a scaled average energy by multiplying the average energy of said second subset times the scaling factor, comparing the threshold value to the scaled average energy, and, if the threshold value is less than or substantially equal to the scaled average energy, equating the start coefficient to the first coefficient of the second subset of first coefficients.

43. The echo cancellation system of claim 41 wherein the end coefficient is determined by selecting a final subset of first coefficients having an average energy, a final coefficient, and a number of coefficients substantially equal to the number of coefficients in the first subset of first coefficients, obtaining a scaled average energy by multiplying the average energy of said second subset times the scaling factor, comparing the threshold value to the scaled average energy, and, if the threshold value is less than or substantially equal to the scaled average energy, equating the end coefficient to the final coefficient of the final subset of first coefficients.

44. A method for canceling an echo wherein the echo is generated by transmitting a first signal through an echo-causing system, comprising the steps of:
deriving a plurality of second coefficients having a start coefficient and an end coefficient, the second coefficients being a subset of a plurality of first coefficients, wherein the start coefficient and end coefficient are determined by applying at least one threshold value to an energy value, said energy value being a function of the energy of a plurality of first coefficients;
receiving a first signal;
outputting a second signal wherein the second signal is a function of the second coefficients and the first signal;
receiving an error signal; and
updating the first coefficients based upon said error signal.

45. A gateway operative to transmit signals between a circuit switched network and a packet based network, comprising:
a plurality of digital to analog encoders and decoders; and
an echo cancellation device wherein said device comprises an adaptive filter having a plurality of second coefficients having a first coefficient and a second coefficient, the second coefficients being a subset of the first coefficients, wherein the first coefficient and second coefficient are determined by applying at least one threshold value to an energy value, said energy value being a function of the energy of a plurality of first coefficients.

46. A method for equalizing a channel, comprising the steps of:
deriving a plurality of second coefficients having a start coefficient and an end coefficient, the second coefficients being a subset of a plurality of first coefficients, wherein the start coefficient and end coefficient are determined by applying at least one threshold value to an energy value, said energy value being a function of the energy of a plurality of first coefficients;
receiving a first signal;
outputting a second signal wherein the second signal is a function of the second coefficients and the first signal;
receiving an error signal; and
updating the first coefficients based upon said error signal.
